(19) United States
(12) Patent Application Publication
(10) Pub. No.: US 2009/0047970 A1
(43) Pub. Date: Feb. 19, 2009

(54) METHOD, APPARATUS AND SYSTEM FOR NETWORK RESOURCE RESERVATION BASED ON MOVING SPEED OF MOBILE TERMINAL, AND MOBILE TERMINAL THEREFOR

(75) Inventors: Won Tae Kim, Chungcheongnam-do (KR); Do Hyung Kim, Daejeon (KR); Hwan Gu Lee, Daejeon (KR); Kyung Hee Lee, Daejeon (KR); Seung Min Park, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/102,450

(22) Filed: Apr. 14, 2008

(30) Foreign Application Priority Data
Aug. 16, 2007 (KR) 10-2007-0082084

(51) Int. Cl. H04Q 7/20; H04M 1/00

(52) U.S. Cl. 455/450; 455/550.1

(57) ABSTRACT

The present invention relates to a method, apparatus and system for network resource reservation and a mobile terminal therefor. Provided are a method, apparatus and system for minimizing unnecessary network resource reservation by predicting an expected direction of a terminal. The method for network resource reservation based on a moving speed of a mobile terminal includes: receiving a request for network resource reservation from the mobile terminal; calculating an expected moving direction of the mobile terminal, based on a speed-based moving probability model represented by a probability density function for a movable direction dependent on the moving speed of the mobile terminal, a moving speed of the mobile terminal, and position information of the mobile terminal; and performing network resource reservation for wireless cells included in the calculated expected moving direction. Thus, unnecessary network resource reservation can be minimized by predicting the moving direction of the terminal.

### CROSS-REFERENCE TO RELATED APPLICATION

This application claims priority to and the benefit of Korean Patent Application No. 2007-82084, filed Aug. 16, 2007, the disclosure of which is incorporated herein by reference in its entirety.

### BACKGROUND

1. Field of the Invention

The present invention relates to a method, apparatus and system for network resource reservation and a mobile terminal therefor, and more particularly, to a method, apparatus and system for network resource reservation based on a moving speed of a mobile terminal, and a mobile terminal therefor.

2. Discussion of Related Art

In conventional network resource reservation, network resources are reserved between end terminals by using a ReSource ReSerVation Protocol (RSVP) of Internet Engineering Task Force (IETF). However, since an RSVP channel is configured in a fixed manner, network resources must be reallocated between end terminals when a terminal moves. This may increase a resource allocation time to degrade communication quality.

To solve this problem, a Mobile-RSVP (MRSVP) method using a combination of the IETF Mobile IP and the RSVP was proposed. The MRSVP method uses a communication structure of a mobile IP, in which a position of a mobile terminal is tracked via a home agent and a local agent and the reconstruction of an RSVP channel is minimized.

For fast RSVP channel establishment, however, network resource reservation should be performed for all wireless cells currently adjacent to a mobile terminal, including wireless networks to which the terminal will not move. This problem will be described with reference to FIG. 1.

FIG. 1 illustrates a network resource reservation scheme using a conventional MRSVP scheme.

In FIG. 1, a mobile terminal is currently located in ‘Cell 1’ and tries to move to ‘Cell 2’. In the conventional MRSVP scheme that does not consider a moving direction of the mobile terminal, network resource reservation is performed for all of ‘Cell 2’ to ‘Cell 7’ adjacent to ‘Cell 1’. Unnecessary network resources for ‘Cell 3’ to ‘Cell 7’ may disable other mobile terminals from making network resource reservation for ‘Cell 3’ to ‘Cell 7’.

Meanwhile, mobile terminals have recently appeared, which can be used in an overlapping network with different types of wireless networks, including a wide-area network such as a Code Division Multiple Access (CDMA) network, a metropolitan network such as a Wireless Broadband Internet (WiBro) network, and a small network such as a Wireless Local Area Network (WLAN) network. When a conventional MRSVP scheme is applied to such an overlapping network, loss increases due to unnecessary network resource reservation. This problem will be described with reference to FIG. 2.

FIG. 2 illustrates an exemplary overlapping environment of different types of wireless networks using a conventional MRSVP.

Referring to FIG. 2, a current position of a mobile terminal belongs to coverage areas of a wireless cell ‘Cell 1’ of a WLAN network, a wireless cell ‘Cell 11’ of a WiBro network, and a wireless cell ‘Cell 21’ of a CDMA network. In this case, even though the mobile terminal tries to move to coverage areas of a wireless cell ‘Cell 2’ of the WLAN network, a wireless cell ‘Cell 12’ of the WiBro network, and a wireless cell ‘Cell 22’ of the CDMA network, the conventional MRSVP performs network resource reservation for all cells adjacent to the cells in which the mobile terminal is currently located, including wireless cells ‘Cell 2’ to ‘Cell 7’ of WLAN network, wireless cells ‘Cell 12’ to ‘Cell 17’ of the WiBro network, and wireless cells ‘Cell 22’ to ‘Cell 27’ of the CDMA network. That is, the network resource reservation is performed for all the cells adjacent to the wireless cells in which the terminal is currently located. Such unnecessary network resource reservation in an overlapping environment of different types of wireless networks increases network resource loss.

Accordingly, there is a need for a method capable of reducing unnecessary waste of network resources by selectively reserving network resources located in an expected moving direction of a terminal.

### SUMMARY OF THE INVENTION

The present invention is directed to a method, apparatus and system for minimizing unnecessary network resource reservation by predicting an moving direction of a terminal, and a mobile terminal therefor.

The present invention is also directed to a method, apparatus and system for performing effective network resource reservation in an overlapped environment of different types of wireless networks, and a mobile terminal therefor.

Other objects of the present invention can be recognized from the following description and embodiments of the present invention.

An aspect of the present invention provides a method for network resource reservation based on a moving speed of a mobile terminal, the method comprising the steps of: receiving a request for network resource reservation from the mobile terminal; calculating an expected moving direction of the mobile terminal, based on a speed-based moving probability model represented by a probability density function for a movable direction dependent on the moving speed of the mobile terminal, the moving speed of the mobile terminal, and position information of the mobile terminal; and performing network resource reservation for wireless cells included in the calculated expected moving direction.

Another aspect of the present invention provides a system for network resource reservation based on a moving speed of a mobile terminal, the system comprising a mobile terminal, a speed-based moving probability model represented by a probability density function for a movable direction dependent on the moving speed of the mobile terminal, a network resource local control device, and a network resource central control device, wherein: the mobile terminal comprises a network resource reservation processing module for requesting the network resource central control device to reserve network resources, the network resource central control device comprises a network resource reservation processing main-module for calculating an expected moving direction of the mobile terminal based on the speed-based moving probability model, the moving speed of the mobile terminal, and position information of the mobile terminal, and requesting the network resource local control device to reserve network resources for wireless cells included in the calculated expected moving direction of the mobile terminal, and the network resource local control device comprises a network resource reservation processing submodule for performing network resource reservation in response to the request for the network resource reservation from the network resource central control device.

Yet another aspect of the present invention provides an apparatus for network resource reservation based on a moving speed of a mobile terminal, the apparatus comprising a network resource reservation managing unit for calculating an expected moving direction of the mobile terminal, based on a speed-based moving probability model represented by a probability density function for a movable direction dependent on the moving speed of the mobile terminal, the moving speed of the mobile terminal, and position information of the mobile terminal, and performing network resource reservation for wireless cells included in the calculated expected moving direction of the mobile terminal.

Yet another aspect of the present invention provides a mobile terminal comprising: a network resource reservation processing module for requesting to reserve network resources to be used by the mobile terminal when the mobile terminal deviates from a coverage area of a wireless cell in which the mobile terminal is currently located; and a network selecting module for selecting a network resource to be used by the mobile terminal from the reserved network resources, based on at least one of signal strength of the network resources, remaining battery lifetime of the mobile terminal, a moving speed of the mobile terminal, and a user's preference.

As described above, according to the present invention, it is possible to minimize unnecessary network resource reservation by predicting a moving direction of a terminal.

It is also possible to perform effective network resource reservation in overlapping environment of different types of wireless networks.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 illustrates a network resource reservation scheme using a conventional MRSVP scheme;

FIG. 2 illustrates an exemplary overlapping environment of different types of wireless networks using a conventional MRSVP;

FIG. 3 is a schematic diagram illustrating a system for network resource reservation based on a moving speed of a terminal according to an exemplary embodiment of the present invention;

FIG. 4 is a block diagram illustrating a mobile terminal according to an exemplary embodiment of the present invention;

FIG. 5 is a block diagram illustrating a network resource local control device according to an exemplary embodiment of the present invention;

FIG. 6 is a block diagram illustrating a network resource central control device according to an exemplary embodiment of the present invention;

FIGS. 7a to 7d illustrate a speed-based moving probability model dependent on a moving speed of a terminal;

FIG. 8 illustrates a network resource reservation range satisfying a critical probability;

FIG. 9 is a flowchart illustrating a method for network resource reservation based on a moving speed of a terminal according to an exemplary embodiment of the present invention;

FIG. 10 is a schematic diagram illustrating a system for network resource reservation based on a moving speed of a mobile terminal according to another exemplary embodiment of the present invention;

FIG. 11 is a block diagram illustrating an apparatus for network resource reservation according to another exemplary embodiment of the present invention; and

FIG. 12 is a flowchart illustrating a method for network resource reservation based on a moving speed of a terminal according to another exemplary embodiment of the present invention.

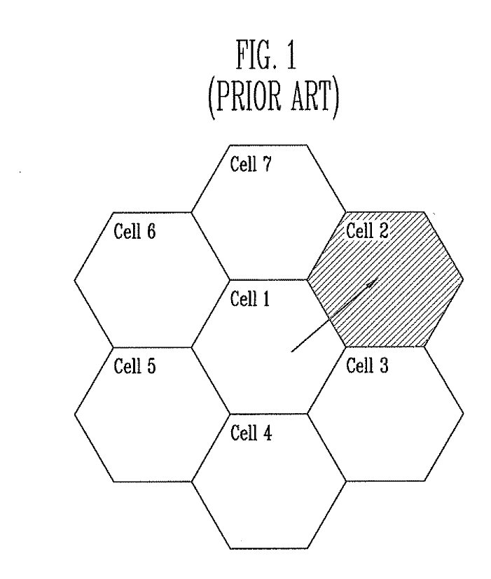

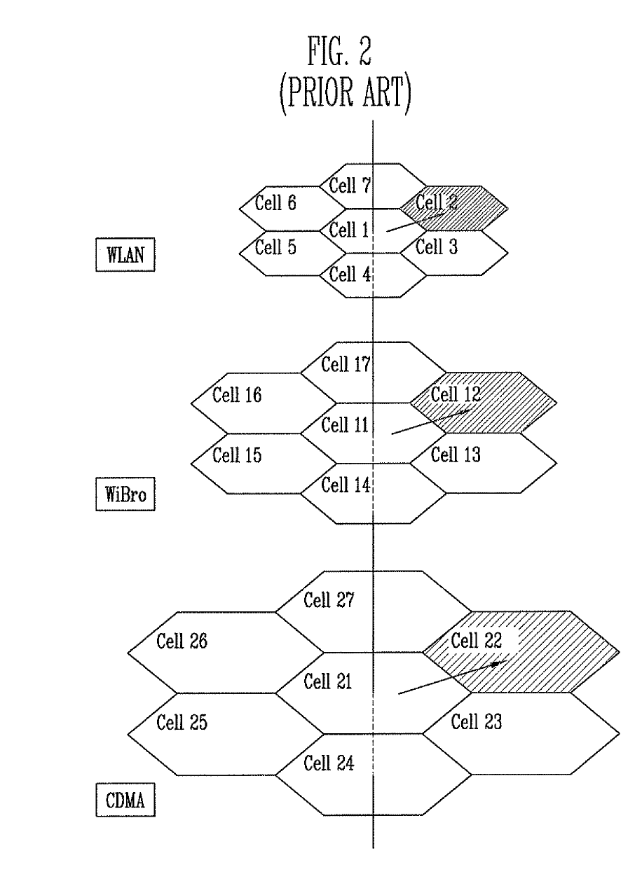

### DETAILED DESCRIPTION OF EXEMPLARY EMBODIMENTS

Hereinafter, preferred embodiments of the present invention will be described in detail with reference to the accompanying drawings. The embodiments of the present invention, however, may be changed into several other forms, and the scope of the present invention should not be construed to be limited to the following embodiments. The embodiments of the present invention are intended to more entirely explain the present invention to those skilled in the art.

FIG. 3 is a schematic diagram illustrating a system for network resource reservation based on a moving speed of a terminal according to an exemplary embodiment of the present invention. The system for network resource reservation based on a moving speed of a terminal according to an exemplary embodiment of the present invention will now be described with reference to FIG. 3.

The system for network resource reservation based on a moving speed of a terminal according to an exemplary embodiment of the present invention includes a mobile terminal 310, a network resource local control device 320, a network resource central control device 330, and a speed-based moving probability model 340.

The mobile terminal 310 according to an exemplary embodiment of the present invention, when deviating from a coverage area of a current network resource, requests the network resource central control device 330 to reserve network resources. The mobile terminal 310 according to an exemplary embodiment of the present invention includes interfaces IF 1 to IF N for signal processing with different types of wireless networks.

Upon receipt of the request for the network resource reservation from the mobile terminal 310, the network resource central control device 330 according to an exemplary embodiment of the present invention calculates an expected moving direction of the mobile terminal 310 based on the speed-based moving probability model 340, and requests the network resource local control device 320 to reserve network resources included in the calculated expected moving direction.

Upon receipt of the request for network resource reservation from the network resource central control device 330, the network resource local control device 320 according to an exemplary embodiment of the present invention reserves the network resources.

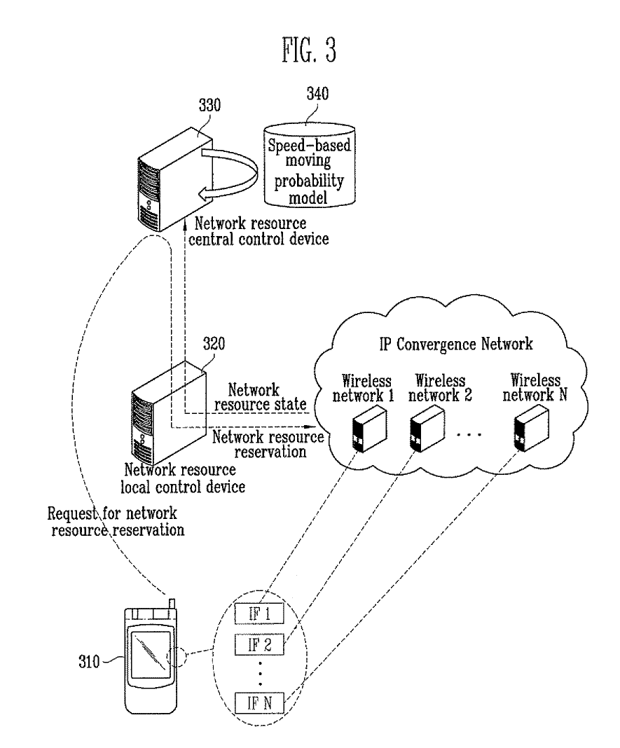

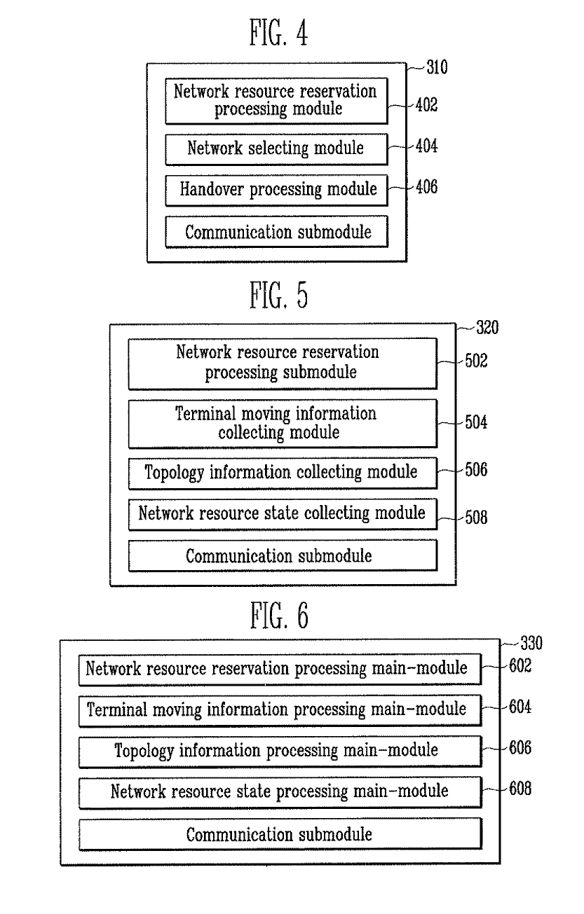

The system for network resource reservation based on a moving speed of a terminal according to an exemplary embodiment of the present invention will now be described in greater detail with reference to FIGS. 4 to 8.

FIG. 4 is a block diagram illustrating the mobile terminal 310 according to an exemplary embodiment of the present invention. The mobile terminal 310 according to an exemplary embodiment of the present invention will now be described in detail with reference to FIG. 4.

The mobile terminal 310 according to an exemplary embodiment of the present invention includes a network resource reservation processing module 402, a network selecting module 404, and a handover processing module 406.

When the mobile terminal 310 deviates from a coverage area of a current network resource, the network resource reservation processing module 402 according to an exemplary embodiment of the present invention requests the network resource central control device 330 to reserve network resources to be used by the mobile terminal 310.

The network selecting module 404 according to an exemplary embodiment of the present invention selects a network resource to be used by the mobile terminal 310 from the network resources reserved in response to the request for the network resource reservation. The selection of the network resource may be made in consideration of signal strength of the reserved network resources, remaining battery lifetime of the mobile terminal 310, a moving speed of the mobile terminal 310, and a user's preference.

If the wireless networks reserved in the expected direction of the mobile terminal 310 are different types of wireless networks, the signal strength of the reserved network resources are considered, for example, to select a wireless network having greater signal strength among such wireless networks.

If wireless cells belonging to different types of wireless networks are reserved for the mobile terminal 310 moving at a high speed, the remaining battery lifetime and the speed of the mobile terminal 310 are considered, for example, to select a wireless network having a larger coverage area. This is because a selection of a wireless network having a smaller coverage area among the wireless cells reserved in the expected direction of the mobile terminal 310 may cause frequent signal interruption and frequent handover processing may rapidly consume the battery.

The user's preference is considered, for example, to select a wireless network having a smaller coverage area and a better communication quality, rather than the wireless network having a larger coverage area, according to settings.

The handover processing module 406 according to an exemplary embodiment of the present invention performs handover to a wireless cell in the wireless network selected by the network selecting module 404 that the mobile terminal 310 will use.

FIG. 5 is a block diagram illustrating the network resource local control device 320 according to an exemplary embodiment of the present invention. The network resource local control device 320 according to an exemplary embodiment of the present invention will be described in detail with reference to FIG. 5.

The network resource local control device 320 according to an exemplary embodiment of the present invention includes a network resource reservation processing submodule 502, a terminal moving information collecting module 504, a topology information collecting module 506, and a network resource state collecting module 508.

The network resource reservation processing submodule 502 according to an exemplary embodiment of the present invention reserves a network resource in response to the request for network resource reservation from the network resource central control device 330.

The network resource reservation processing submodule 502 according to an exemplary embodiment of the present invention cancels a network resource in response to a request for network resource cancel from the network resource central control device 330.

The terminal moving information collecting module 504 according to an exemplary embodiment of the present invention periodically collects a moving speed of the mobile terminal 310 and outputs the same to the network resource central control device 330.

The topology information collecting module 506 according to an exemplary embodiment of the present invention periodically collects position information of the mobile terminal 310 and outputs the same to the network resource central control device 330. The position information of the mobile terminal 310 may be collected, for example, by triangulation or a Global Positioning System (GPS)-based scheme using a position of a base station on the network recognized from collected network topology information.

The network resource state collecting module 508 according to an exemplary embodiment of the present invention periodically collects a network resource state of each wireless network and outputs the same to the network resource central control device 330. For example, the network resource state refers to a state where a specific wireless cell is not available due to excessive network resource reservation for the wireless cell or a state where a wireless cell is not available due to damaged equipment, such as a damaged base station. The network resource state collecting module 508 collects such a network resource state and outputs the same to the network resource central control device 330 so that effective network resource reservation is performed.

FIG. 6 is a block diagram illustrating the network resource central control device 330 according to an exemplary embodiment of the present invention. The network resource central control device 330 according to an exemplary embodiment of the present invention will now be described in detail with reference to FIG. 6.

The network resource central control device 330 according to an exemplary embodiment of the present invention includes a network resource reservation processing main-module 602, a terminal moving information processing main-module 604, a topology information processing main-module 606, and a network resource state processing main-module 608.

Upon receipt of a request for network resource reservation from the mobile terminal 310, the network resource reservation processing main-module 602 according to an exemplary embodiment of the present invention calculates an expected moving direction of the mobile terminal 310 based on the speed-based moving probability model 340, the moving speed of the mobile terminal 310, and position information of the mobile terminal 310, and requests the network resource local control device 320 to reserve network resources for wireless cells included in the calculated expected moving direction of the mobile terminal 310.

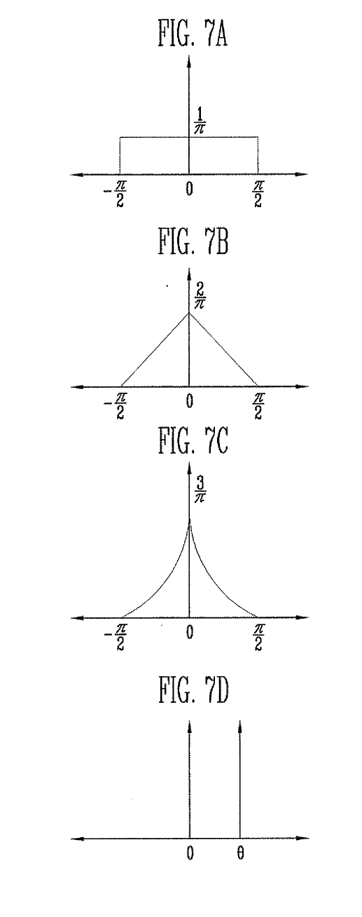

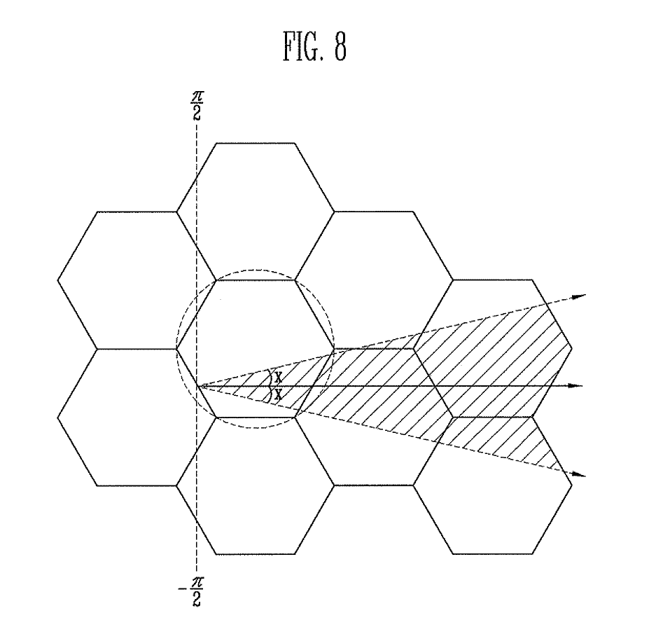

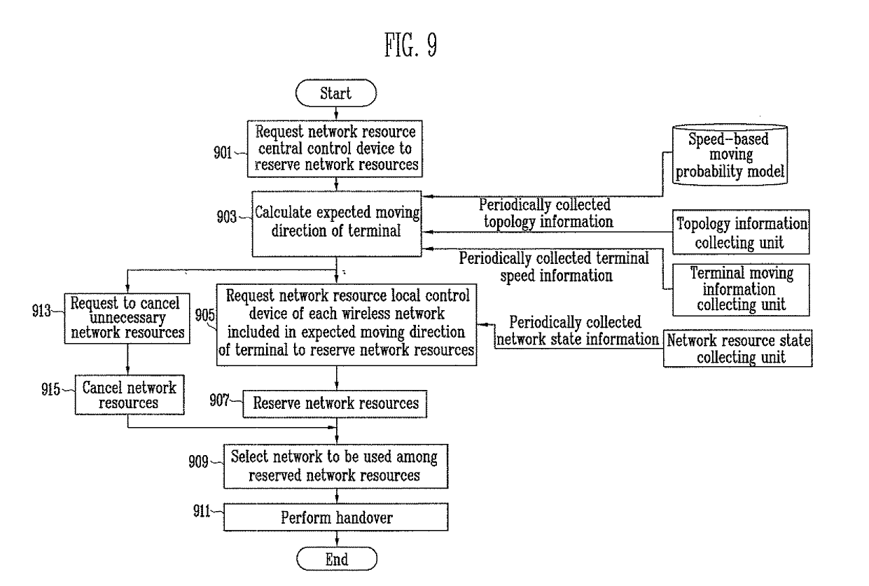

The speed-based moving probability model 340 refers to a probability model representing the expected moving direction of the mobile terminal 310 in speed ranges divided by predetermined criteria, as a probability density function, in consideration of speeds of various vehicles on which the mobile terminal 310 may be mounted. The speed-based moving probability model 340 will now be described in detail with reference to FIGS. 7a to 7d.

FIGS. 7a to 7d illustrate the speed-based moving probability model 340 dependent on the moving speed of the terminal. The speed-based moving probability model 340 shown in FIGS. 7a to 7d may be built in consideration of an inertial force dependent on a speed of a moving object, shapes of a road and a railroad, etc.

FIG. 7a illustrates a probability model for an expected moving direction when the mobile terminal 310 moves at 0 km/h to 15 km/h. This speed range is determined in consideration of a speed at which a person walks or runs.

In FIG. 7a, a horizontal axis denotes a direction-changeable range of the mobile terminal 310 and a vertical axis denotes a probability density function ƒ(θ) for the expected moving direction of the mobile terminal 310 obtained based on the moving speed of the mobile terminal 310. The same applies to FIGS. 7b to 7d. The actual direction-changeable range of the mobile terminal 310 is 2π but, for convenience of description, the direction-changeable range of the mobile terminal 310 will now be described as being π/2 at the left and right from the current moving direction of the mobile terminal 310.

The probability density function of the speed-based moving probability model 340 as shown in FIG. 7a is represented by Equation 1:

$$f ( θ ) = \{ \begin{matrix}\frac{1}{π} & ( - \frac{π}{2} \leq θ \leq \frac{π}{2} ) \\ 0 & ( else ) ,\end{matrix} \qquad Equation 1$$

where θ denotes an angle at which the mobile terminal 310 enters the wireless cell.

As shown in FIG. 7a, when the moving speed of the mobile terminal 310 is as slow as 0 km/h to 15 km/h, the mobile terminal 310 may move with the same probability of 1/π in the direction-changeable range of

$$- \frac{π}{2} \leq θ \leq \frac{π}{2} .$$

FIG. 7b illustrates a probability model for an expected moving direction when the mobile terminal 310 moves at 15 km/h to 80 km/h. This speed range is determined in consideration of a speed of vehicles in a metropolitan region.

A probability density function of the speed-based moving probability model 340 as shown in FIG. 7b is represented by Equation 2:

$$f ( θ ) = \{ \begin{matrix}\frac{4}{{π}^{2}} θ + \frac{2}{π} & ( - \frac{π}{2} \leq θ \leq 0 ) \\ 0 & ( else ) \\ - \frac{4}{{π}^{2}} θ + \frac{2}{π} & ( 0 \leq θ \leq \frac{π}{2} ) .\end{matrix} \qquad Equation 2$$

As in FIG. 7b, when the moving speed of the mobile terminal 310 ranges from 15 km/h to 80 km/h, the mobile terminal 310 is most likely to move in a current direction, and the probability density function is represented as a first order function at the left and right.

FIG. 7c illustrates a probability model for an expected moving direction when the mobile terminal 310 moves at 80 km/h to 150 km/h. This speed range is determined in consideration of a speed of vehicles on a highway.

A probability density function of the speed-based moving probability model 340 as shown in FIG. 7c is represented by Equation 3:

$$f ( θ ) = \{ \begin{matrix}\frac{12}{{π}^{3}} {( θ + \frac{π}{2} )}^{2} & ( - \frac{π}{2} \leq θ \leq 0 ) \\ 0 & ( else ) \\ \frac{12}{{π}^{3}} {( θ - \frac{π}{2} )}^{2} & ( 0 \leq θ \leq \frac{π}{2} ) .\end{matrix} \qquad Equation 3$$

As in FIG. 7c, when the moving speed of the mobile terminal 310 ranges from 80 km/h to 150 km/h, the mobile terminal 310 is most likely to move in a current direction, and the probability density function is represented as a second order function at the left and right.

FIG. 7d illustrates a probability model for an expected moving direction when the mobile terminal 310 moves at 150 km/h or more. This speed range is determined in consideration of a speed of vehicles on a highway.

A probability density function of the speed-based moving probability model 340 as shown in FIG. 7d is represented by Equation 4:

$$f ( θ ) = \{ \begin{matrix}∞ & ( if θ ) \\ 0 & ( else ) .\end{matrix} \qquad Equation 4$$

As in FIG. 7d, when the moving speed of the mobile terminal 310 is 150 km/h or more, the mobile terminal 310 is expected to move only in a current moving direction.

For convenience of description, FIGS. 7a to 7d show examples of the probability models in any speed range, and accordingly the present invention is not limited to Equations above.

Referring to FIG. 6, the network resource reservation processing main-module 602 according to an exemplary embodiment of the present invention calculates an expected moving direction of the mobile terminal 310 satisfying a predetermined critical probability. By calculating the expected moving direction of the mobile terminal 310 satisfying the critical probability, network resource waste due to unnecessary network resource reservation can be reduced by performing network resource reservation only for an expected moving direction having a higher mobility probability among the expected moving directions calculated based on the probability models as shown in FIGS. 7a to 7d. If the predetermined critical probability is α, the expected moving direction of the mobile terminal 310 satisfying the critical probability α is represented by Equation 5:

$${\int }_{- x}^{x} f ( θ ) d θ = α . \qquad Equation 5$$

Equation 5 applied to Equation 3 representing the probability model of FIG. 7c is translated into Equation 6. In this case, it is assumed that the predetermined critical probability α is 0.6.

$$2 {\int }_{0}^{x} \frac{12}{{π}^{3}} {( θ - \frac{π}{2} )}^{2} d θ = 0.6 \\ x = \frac{1}{7.7} π \qquad Equation 6$$

That is, network resources is reserved only for a range

$$- \frac{1}{7.7} π \leq θ \leq \frac{1}{7.7} π$$

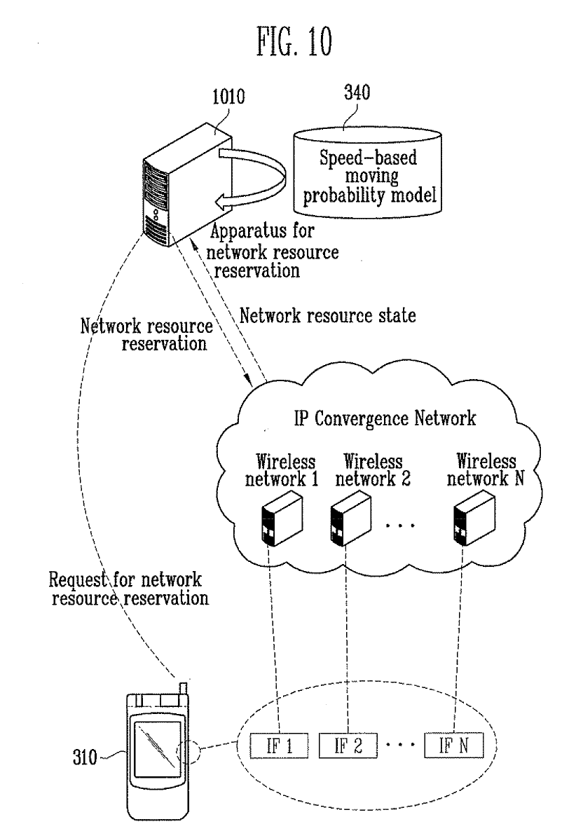

satisfying the critical probability (α=0.6), and this can minimize network resource waste, which may be caused by unnecessary reservation for network resource. This will be described with reference to FIG. 8.

FIG. 8 illustrates a network resource reservation range satisfying a critical probability.

In the speed-based moving probability model 340 shown in FIG. 7c, the movable direction of the mobile terminal 310 ranges from

$$- \frac{π}{2} to \frac{π}{2}$$

from the current moving direction of the mobile terminal 310. In this case, the expected moving direction of the mobile terminal 310 re-calculated by applying the critical probability shown in Equation 5 to the speed-based moving probability model 340 of FIG. 7c is represented by Equation 6. FIG. 8 illustrates a range of the re-calculated expected moving direction. A range of ±χ from the moving direction of the mobile terminal 310 indicated by a solid line in FIG. 8 indicates the expected moving direction of the mobile terminal 310 satisfying the critical probability. In this case, the network resource reservation processing main-module 602 according to an exemplary embodiment of the present invention requests the network resource reservation processing submodule 502 to reserve network resources for wireless cells existing in the expected mobility range of the mobile terminal 310 satisfying the critical probability.

Referring to FIG. 6, the network resource reservation processing main-module 602 according to an exemplary embodiment of the present invention requests the network resource local control device 320 to reserve network resources for cells adjacent to a wireless cell in which the mobile terminal 310 is currently located, among the wireless cells included in the calculated expected moving direction.

The network resource reservation processing main-module 602 according to an exemplary embodiment of the present invention may request the network resource local control device 320 to reserve network resources for wireless cells located within a predetermined distance from the wireless cell in which the mobile terminal 310 is currently located, among the wireless cells included in the calculated expected moving direction. This is for reserving remote wireless cells and obtaining network resources to be used, because a time to pass adjacent wireless cells is very short, for example, when a coverage area of an adjacent wireless cell has a radius of 1 km and the mobile terminal 310 is moving at 100 km/h.

When wireless cells belonging to different types of wireless networks, such as a WLAN network, a CDMA network, a WiBro network and the like, are included in the calculated expected moving direction, the network resource reservation processing main-module 602 according to an exemplary embodiment of the present invention requests to reserve network resources for a wireless cell belonging to a wireless network having the largest coverage area (e.g., the CDMA network) among the different types of wireless networks. This is because reservation of a wireless network having a small coverage area (e.g., the WLAN) requires frequent handover processing, causing fast consumption of the battery of the mobile terminal 310 and system overload.

Upon receipt of a request for network resource reservation for the wireless cell belonging to a wireless network having the largest coverage area, the network resource reservation processing main-module 602 according to an exemplary embodiment of the present invention may reserve all wireless cells of different types of wireless networks included in a wireless cell belonging to the wireless network having the largest coverage area. In this case, the wireless cells of the different types of wireless networks included in the wireless cell belonging to the wireless network having the largest coverage area may be reserved for a calculated maximum residence time for which the mobile terminal 310 can stay in the wireless network having the largest coverage area.

The maximum residence time t_{MAX} for which the mobile terminal 310 can stay in the wireless network having the largest coverage area may be calculated by calculating an average moving distance E of the mobile terminal 310 in consideration of a probability density function ƒ(θ) in a coverage area of the wireless network having the largest coverage area, and dividing the calculated average moving distance by the speed of the mobile terminal 310. The average moving distance E is represented by Equation 7:

E=∫S·ƒ(θ)dθ=∫2R cos θ·ƒ(θ)dθ, Equation 7

where S denotes a moving distance of the terminal dependent on the entering angle θ of the terminal, and R denotes a radius of the coverage area of the wireless cell.

Equation 8 is used to obtain the maximum residence time t_{MAX} for which the mobile terminal 310 can stay in the wireless cell by using the average moving distance calculated by Equation 7:

$${t}_{MAX} = \frac{E}{v} , \qquad Equation 8$$

where v denotes a current moving speed of the mobile terminal 310.

Equation 7 and Equation 8, which are used to obtain the maximum residence time t_{MAX} for which the mobile terminal 310 can stay in the wireless cell, are applied to the speed-based moving probability model 340 represented by Equation 1 to Equation 4, resulting in Equation 9 to Equation 13.

Equation 9 is used to obtain an average moving distance of the mobile terminal 310 in consideration of the probability density function ƒ(θ) by applying to Equation 7 the speed-based moving probability model 340 represented by Equation 1:

$$E = {\int }_{- \frac{π}{2}}^{\frac{π}{2}} \frac{1}{π} ( 2 R cos θ ) d θ = \frac{4 R}{π} . \qquad Equation 9$$

It can be seen from Equation 9 that the average moving distance of the mobile terminal 310 in the speed-based moving probability model 340 represented by Equation 1 is

$$\frac{4 R}{π} .$$

Equation 9, which is used to obtain the average moving distance of the mobile terminal 310, is applied to Equation 8, resulting in Equation 10:

$${t}_{MAX} = \frac{4 R}{π} \times \frac{1}{v} = \frac{4 R}{π v} . \qquad Equation 10$$

The maximum residence time for which the mobile terminal 310 can stay in the largest wireless cell in the speed-based moving probability model 340 represented by Equation 1 becomes

$$\frac{4 R}{π v} .$$

The network resource reservation processing main-module 602 requests the network resource local control device 320 to reserve network resources for all wireless cells included in the expected moving direction of the mobile terminal 310, for a time of

$$\frac{4 R}{π v} .$$

Maximum residence times of the mobile terminal 310 in the speed-based moving probability model 340 represented by Equation 2 to Equation 4 are represented by Equation 11 to Equation 13.

$$\begin{matrix}\begin{matrix}{t}_{MAX} = \{ 2 {\int }_{0}^{\frac{π}{2}} ( 2 R cos θ ) \cdot ( - \frac{4}{{π}^{2}} θ + \frac{2}{π} ) d θ \} \times \frac{1}{v} \\ = \frac{16 R}{{π}^{2}} \times \frac{1}{π} \\ = \frac{16 R}{{π}^{2} v} ,\end{matrix} & Equation 11 \\ \begin{matrix}{t}_{MAX} = \{ 2 {\int }_{0}^{\frac{π}{2}} ( 2 R cos 0 ) \cdot {( - \frac{12}{{π}^{3}} \cdot ( 0 - \frac{π}{2} ) )}^{2} d 0 \} \times \frac{1}{v} \\ = 1.767 R \times \frac{1}{v} \\ = \frac{1.767 R}{v} ,\end{matrix} \\ and & Equation 12 \\ {t}_{MAX} = \frac{2 R}{v} . & Equation 13\end{matrix}$$

Thus, the network resource reservation processing main-module 602 according to an exemplary embodiment of the present invention may calculate the maximum residence time for which the mobile terminal 310 stays in the largest wireless cell in the speed-based moving probability model 340, and may request the network resource local control device 320 to reserve network resources for all the wireless cells included in the expected moving direction of the mobile terminal 310 for the calculated maximum residence time.

The network resource reservation processing main-module 602 according to an exemplary embodiment of the present invention also requests the resource local control device 320 to cancel a previously reserved network resource for the mobile terminal 310 when the previously reserved network resource is not included in the calculated expected moving direction.

The terminal moving information processing main-module 604 according to an exemplary embodiment of the present invention receives moving information of the mobile terminal 310 from the network resource local control device 320, stores the moving information, and outputs the moving information to the network resource reservation processing main-module 602.

The topology information processing main-module 606 according to an exemplary embodiment of the present invention receives network topology information from the network resource local control device 320, stores the network topology information, and outputs the network topology information to the network resource reservation processing main-module 602.

The network resource state processing main-module 608 according to an exemplary embodiment of the present invention may receive the network resource state from the network resource local control device 320 and analyze the network resource state. The network resource reservation processing main-module 602 may use the analyzed network resource state to request the network resource local control device 320 to reserve the network resources. For example, when it is determined, as a result of analyzing the network resource state, that a wireless cell belonging to the CDMA network among the wireless networks included in the expected moving direction of the mobile terminal 310 is currently not available, the network resource reservation processing main-module 602 may perform reservation for wireless cells belonging to the WiBro network rather than the CDMA network, based on such information.

FIG. 9 is a flowchart illustrating a method for network resource reservation based on a moving speed of a terminal according to an exemplary embodiment of the present invention. The method for network resource reservation based on a moving speed of a terminal according to an exemplary embodiment of the present invention will now be described with reference to FIG. 9. Here, the same features as those of the system for network resource reservation based on a moving speed of a mobile terminal in FIGS. 3 to 8 will not be described.

Upon receipt of the request for the network resource reservation from the mobile terminal 310 in step 901, the network resource central control device 330 calculates the expected moving direction of the mobile terminal 310 in step 903 and then proceeds to step 905.

In step 905, the network resource central control device 330 requests the network resource local control device 320 of each wireless network included in the expected moving direction of the mobile terminal 310 calculated in step 903 to reserve network resources.

In step 907, the network resource local control device 320 reserves the network resource in response to the request from network resource central control device 330.

In step 909, the mobile terminal 310 selects a network to be used among the network resources reserved in step 907, and then proceeds to step 911.

In step 911, the mobile terminal 310 performs handover to the network to be used.

Meanwhile, when unnecessary network resources that do not belong to the expected moving direction of the mobile terminal 310 calculated in step 903 are reserved, the process proceeds to step 913, in which the network resource central control device 330 requests the network resource local control device 320 to cancel the unnecessary network resources. In step 915, the network resource local control device 320 cancels the unnecessary network resources.

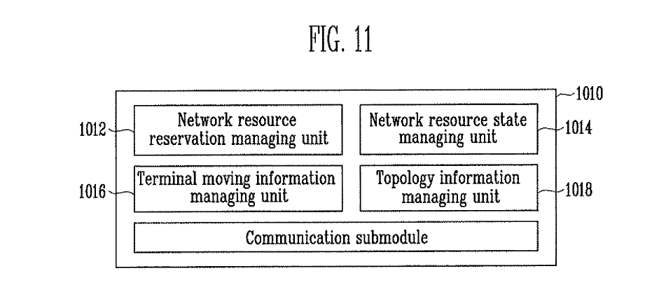

FIG. 10 is a schematic diagram illustrating a system for network resource reservation based on a moving speed of a mobile terminal according to another exemplary embodiment of the present invention. The system for network resource reservation based on a moving speed of a mobile terminal according to another exemplary embodiment of the present invention will now be described with reference to FIG. 10. Here, the same features as those of the system for network resource reservation based on a moving speed of a mobile terminal in FIG. 3 will not be described.

The system for network resource reservation based on a moving speed of a mobile terminal according to an exemplary embodiment of the present invention includes a mobile terminal 310, a network resource reservation apparatus 1010, and a speed-based moving probability model 340.

The mobile terminal 310 according to another exemplary embodiment of the present invention, when deviating from a coverage area of the current network resource, requests the network resource central control device 330 to reserve network resources to be used.

The network resource reservation apparatus 1010 according to another exemplary embodiment of the present invention acts as the network resource local control device 320 and the network resource central control device 330 according to an exemplary embodiment of the present invention.

That is, the network resource reservation apparatus 1010 according to another exemplary embodiment of the present invention calculates the expected moving direction of the mobile terminal 310 based on the speed-based moving probability model 340 upon receipt of the request for the network resource reservation from the mobile terminal 310, and reserves network resources included in the calculated expected moving direction. The apparatus for network resource reservation based on a moving speed of a terminal according to another exemplary embodiment of the present invention will now be described in greater detail with reference to FIG. 11.

FIG. 11 is a block diagram illustrating an apparatus for network resource reservation according to another exemplary embodiment of the present invention. The apparatus for network resource reservation according to another exemplary embodiment of the present invention acts as the network resource local control device 320 and the network resource central control device 330 according to an exemplary embodiment of the present invention, as described above. The apparatus for network resource reservation according to an exemplary embodiment of the present invention will now be described with reference to FIG. 11. Here, the same features as those of the network resource local control device 320 and the network resource central control device 330 in FIGS. 5 to 8 will not be described.

The network resource reservation apparatus 1010 according to another exemplary embodiment of the present invention includes a network resource reservation managing unit 1012, a network resource state managing unit 1014, a terminal moving information managing unit 1016, and a topology information managing unit 1018.

The network resource reservation managing unit 1012 according to another exemplary embodiment of the present invention acts as the network resource reservation processing submodule 502 and the network resource reservation processing main-module 602 according to an exemplary embodiment of the present invention.

That is, the network resource reservation managing unit 1012 according to another exemplary embodiment of the present invention calculates an expected moving direction of the mobile terminal 310 based on the speed-based moving probability model 340, the moving speed of the mobile terminal 310, and the position information of the mobile terminal 310 upon a request for network resource reservation from the mobile terminal 310, and reserves network resources for wireless cells included in the calculated expected moving direction of the mobile terminal 310.

The network resource reservation managing unit 1012 according to another exemplary embodiment of the present invention calculates an expected moving direction of the mobile terminal 310 satisfying a predetermined critical probability.

The network resource reservation managing unit 1012 according to another exemplary embodiment of the present invention also performs network resource reservation for cells adjacent to a wireless cell in which the mobile terminal 310 is currently located, among the wireless cells included in the calculated expected moving direction.

The network resource reservation managing unit 1012 according to another exemplary embodiment of the present invention performs network resource reservation for wireless cells located within a predetermined distance from the wireless cell in which the mobile terminal 310 is currently located, among the wireless cells included in the calculated expected moving direction.

If wireless cells belonging to different types of wireless networks, such as a WLAN, a CDMA, and a WiBro, are included in the calculated expected moving direction, the network resource reservation managing unit 1012 according to another exemplary embodiment of the present invention may perform network resource reservation for wireless cells belonging to a wireless network having the largest coverage area (e.g., the CDMA network) among the different types of wireless networks.

When the network resource reservation is performed for the wireless cell belonging to the wireless network having the largest coverage area, the network resource reservation managing unit 1012 according to another exemplary embodiment of the present invention may reserve all wireless cells of different types of wireless networks included in the wireless cell belonging to a wireless network having the largest coverage area. In this case, the wireless cells of the different types of wireless networks included in the wireless cell belonging to the wireless network having the largest coverage area may be reserved for a calculated maximum residence time for which the mobile terminal 310 can stay in the wireless network having the largest coverage area.

When a previously reserved network resource for the mobile terminal 310 is not included in the calculated expected moving direction, the network resource reservation managing unit 1012 according to another exemplary embodiment of the present invention cancels the previously reserved network resource.

The network resource state managing unit 1014 according to another exemplary embodiment of the present invention acts as the network resource state collecting module 508 and the network resource state processing main-module 608 according to the exemplary embodiment of the present invention.

That is, the network resource state managing unit 1014 according to another exemplary embodiment of the present invention periodically collects a network resource state of each wireless network and outputs the same to the network resource reservation managing unit 1012 so that effective network resource reservation is performed.

The terminal moving information managing unit 1016 according to another exemplary embodiment of the present invention acts as the terminal moving information collecting module 504 and the terminal moving information processing main-module 604 according to the exemplary embodiment of the present invention.

That is, the terminal moving information managing unit 1016 according to another exemplary embodiment of the present invention periodically collects the moving speed of the mobile terminal 310 and outputs the same to the network resource reservation managing unit 1012.

The topology information managing unit 1018 according to another exemplary embodiment of the present invention acts as the topology information collecting module 506 and the topology information processing main-module 606 according to the exemplary embodiment of the present invention.

That is, the topology information managing unit 1018 according to another exemplary embodiment of the present invention periodically collects position information of the mobile terminal 310 and outputs the same to the network resource reservation managing unit 1012.

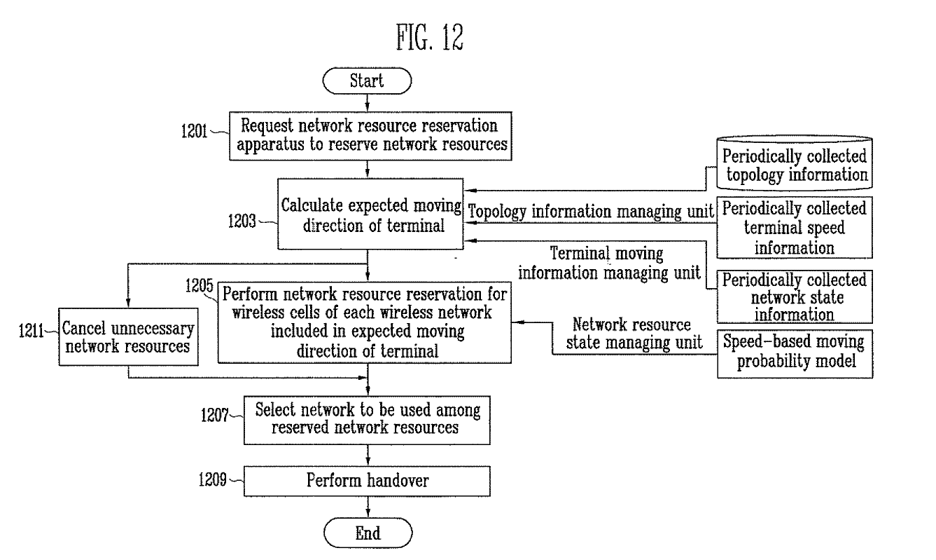

FIG. 12 is a flowchart illustrating a method for network resource reservation based on a moving speed of a terminal according to another exemplary embodiment of the present invention. The method for network resource reservation based on a moving speed of a terminal according to another exemplary embodiment of the present invention will now be described with reference to FIG. 12. Here, the same features as those of the system and apparatus for network resource reservation based on a moving speed of a mobile terminal in FIGS. 10 and 11 will not be described.

Upon receipt of the request for the network resource reservation from the mobile terminal 310 in step 1201, the network resource reservation managing unit 1012 calculates the expected moving direction of the terminal in step 1203 and then proceeds to step 1205.

In step 1205, the network resource reservation managing unit 1012 performs network resource reservation for wireless cells of each wireless network included in the expected moving direction of the terminal calculated in step 903.

In step 1207, the mobile terminal 310 selects a network to be used among the network resources reserved in step 1205, and proceeds to step 1209.

In step 1209, the mobile terminal 310 performs handover to the network to be used.

Meanwhile, when unnecessary network resources that do not belong to the expected moving direction of the mobile terminal 310 calculated in step 1203 are reserved, the process proceeds to step 1211, in which the network resource reservation managing unit 1012 cancels the unnecessary network resources.

While the invention has been shown and described with reference to certain exemplary embodiments thereof, it will be understood by those skilled in the art that various changes in form and details may be made therein without departing from the spirit and scope of the invention as defined by the appended claims.

1. A method for network resource reservation based on a moving speed of a mobile terminal, the method comprising:
receiving a request for network resource reservation from the mobile terminal;
calculating an expected moving direction of the mobile terminal, based on a speed-based moving probability model represented by a probability density function for a movable direction dependent on the moving speed of the mobile terminal, the moving speed of the mobile terminal, and position information of the mobile terminal; and
performing network resource reservation for wireless cells included in the calculated expected moving direction.

2. The method of claim 1, further comprising dividing the moving speed of the mobile terminal into speed sections, and building the speed-based moving probability model for a movable direction dependent on the moving speed of the mobile terminal in each speed section.

3. The method of claim 1, further comprising periodically collecting the moving speed of the mobile terminal and position information of the mobile terminal.

4. The method of claim 1, wherein the calculating an expected moving direction of the mobile terminal comprises the step of calculating the expected moving direction of the mobile terminal satisfying a predetermined critical probability.

5. The method of claim 1, wherein the performing network resource reservation comprises the step of performing the network resource reservation for cells adjacent to a wireless cell in which the mobile terminal is currently located, among the wireless cells included in the calculated expected moving direction.

6. The method of claim 1, wherein the performing network resource reservation comprises the step of, when wireless cells belonging to different types of wireless networks are included in the calculated expected moving direction, performing network resource reservation for wireless cells belonging to a wireless network having the largest coverage area among the different types of wireless networks and included in the calculated expected moving direction.

7. The method of claim 6, wherein the performing network resource reservation comprises:
obtaining an average moving distance by which the mobile terminal can move, in the wireless cell belonging to the wireless network having the largest coverage area, based on the probability density function;
calculating a time for which the mobile terminal can stay in the wireless cell belonging to the wireless network having the largest coverage area, based on the average moving distance of the mobile terminal and the moving speed of the mobile terminal; and
performing network resource reservation for wireless cells of all wireless networks included in the calculated expected moving direction, for the calculated time.

8. The method of claim 1, further comprising, when a previously reserved network resource for the mobile terminal is not included in the calculated expected moving direction, canceling the reserved network resource.

9. The method of claim 1, further comprising selecting a network resource to be used by the mobile terminal from the reserved network resources, based on at least one of the signal strength of the reserved network resources, remaining battery lifetime of the mobile terminal, the moving speed of the mobile terminal, and a user's preference.

10. The method of claim 9, further comprising performing handover for use of the selected network resource.

11. A system for network resource reservation based on a moving speed of a mobile terminal, the system comprising a mobile terminal, a speed-based moving probability model represented by a probability density function for a movable direction dependent on the moving speed of the mobile terminal, a network resource local control device, and a network resource central control device, wherein:
the mobile terminal comprises a network resource reservation processing module for requesting the network resource central control device to reserve network resources,
the network resource central control device comprises a network resource reservation processing main-module for calculating an expected moving direction of the mobile terminal based on the speed-based moving probability model, the moving speed of the mobile terminal, and position information of the mobile terminal, and requesting the network resource local control device to reserve network resources for wireless cells included in the calculated expected moving direction of the mobile terminal, and
the network resource local control device comprises a network resource reservation processing submodule for performing network resource reservation in response to the request for the network resource reservation from the network resource central control device.

12. An apparatus for network resource reservation based on a moving speed of a mobile terminal, the apparatus comprising a network resource reservation managing unit for calculating an expected moving direction of the mobile terminal, based on a speed-based moving probability model represented by a probability density function for a movable direction dependent on the moving speed of the mobile terminal, the moving speed of the mobile terminal, and position information of the mobile terminal, and performing network resource reservation for wireless cells included in the calculated expected moving direction of the mobile terminal.

13. The apparatus of claim 12, wherein the speed-based moving probability model is represented by a probability density function for a movable direction dependent on the moving speed of the mobile terminal in each moving speed section of the mobile terminal.

14. The apparatus of claim 12, further comprising:
a terminal moving information managing unit for periodically collecting the moving speed of the mobile terminal and outputting the same to the network resource reservation managing unit; and
a topology information managing unit for periodically collecting position information of the mobile terminal and outputting the same to the network resource reservation managing unit.

15. The apparatus of claim 12, wherein the network resource reservation managing unit calculates an expected moving direction of the mobile terminal satisfying a predetermined critical probability.

16. The apparatus of claim 12, wherein the network resource reservation managing unit performs network resource reservation for wireless cells existing within a predetermined distance from a wireless cell in which the mobile terminal is currently located, among the wireless cells included in the calculated expected moving direction, based on the moving speed of the mobile terminal.

17. The apparatus of claim 12, wherein the network resource reservation managing unit performs, when wireless cells belonging to different types of wireless networks are included in the calculated expected moving direction, network resource reservation for wireless cells belonging to a wireless network having the largest coverage area among the different types of wireless networks and included in the calculated expected moving direction.

18. The apparatus of claim 12, wherein the network resource reservation managing unit cancels a previously reserved network resource for the mobile terminal when the previously reserved network resource is not included in the calculated expected moving direction.

19. A mobile terminal comprising:
a network resource reservation processing module for requesting to reserve network resources to be used by the mobile terminal when the mobile terminal deviates from a coverage area of a wireless cell in which the mobile terminal is currently located; and
a network selecting module for selecting a network resource to be used by the mobile terminal from the reserved network resources, based on at least one of signal strength of the network resources, remaining battery lifetime of the mobile terminal, a moving speed of the mobile terminal, and a user's preference.

20. The mobile terminal of claim 19, further comprising a handover processing module for performing handover for use of the selected network resource.
